(19) United States
(12) Patent Application Publication
(10) Pub. No.: US 2007/0053662 A1
(43) Pub. Date: Mar. 8, 2007

(54) PLAYBACK APPARATUS AND PLAYBACK METHOD

(76) Inventors: Yoshikata Tobita, Fuchu-shi (JP); Toru Kambayashi, Chigasaki-shi (JP); Yuji Nagai, Sagamihara-shi (JP); Seiichi Nakamura, Inagi-shi (JP); Yoshikazu Shiomi, Hamura-shi (JP); Takero Kobayashi, Akishima-shi (JP); Kosuke Haruki, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/469,244

(22) Filed: Aug. 31, 2006

(30) Foreign Application Priority Data
Sep. 1, 2005 (JP) 2005-253854

(51) Int. Cl. H04N 7/00

(52) U.S. Cl. 386/95

(57) ABSTRACT

According to one embodiment, a playback apparatus includes a unit which determines whether a value of a pointer included in each of video object units read out of a storage media is larger than the total number of hash values in a content hash table stored in the storage media, a unit which computes a hash value of a video object unit selected at a given probability from among the video object units read out of the storage media and determines whether the computed hash value coincides with a hash value stored in a hash entry indicated by a pointer included in the selected video object unit, and a unit which stops playing back digital content when the value of the pointer is larger than the total number of hash values or when the computed hash value does not coincide with the hash value stored in the hash entry.

### CROSS-REFERENCE TO RELATED APPLICATIONS

This application is based upon and claims the benefit of priority from Japanese Patent Application No. 2005-253854, filed Sep. 1, 2005, the entire contents of which are incorporated herein by reference.

### BACKGROUND

1. Field

One embodiment of the invention relates to a playback apparatus for playing back a digital content including a plurality of video object units, which is stored in storage media, and a method of doing the same.

2. Description of the Related Art

Playback apparatuses (players) capable of processing high-definition (HD) video have recently been developed as a technology for digitally compressing and coding moving images progresses

The above players employ storage media such as a high-definition digital versatile disc (HD DVD). Both HD video data and high-quality surround audio data can thus be packaged in a single piece of storage media.

Conventionally, an encryption technology such as a content scramble system (CSS) has been known as one for protecting the digital content stored in the storage media against unauthorized copy.

Jpn. Pat. Appln. KOKAI Publication No. 2001-75868 discloses a playback apparatus having a function of restricting the number of times a content can be played back, the number of times a content can be copied, etc. using content playback control information. The playback apparatus computes a hash value corresponding to the content playback control information in order to detect whether the content playback control information is falsified.

Recently, unauthorized copy and falsification of digital contents, such as video data and audio data, has been made and accordingly unauthorized digital contents start to be distributed as pirated DVDs. There is possibility that HD DVDs recorded with digital contents including HD video images will be distributed as pirated ones.

In order to prevent pirated HD DVDs from being created and distributed, a system for disabling the playback of the pirated HD DVDs is required.

In terms of copyright, too, a new function has to be fulfilled to reliably prevent an unauthorized digital content, such as a falsified digital content and an unauthorized copy of a digital content, from being played back.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of a playback apparatus according to an embodiment of the invention;

FIG. 2 is an exemplary block diagram of a content check unit provided in the playback apparatus shown in FIG. 1;

FIG. 3 is an exemplary diagram showing a physical data structure of storage media used in the playback apparatus shown in FIG. 1;

FIG. 4 is an exemplary diagram of the structure of a content that is played back by the playback apparatus shown in FIG. 1;

FIG. 5 is an exemplary diagram showing EVOBs that compose the content that is played back by the playback apparatus shown in FIG. 1;

FIG. 6 is an exemplary diagram showing a content hash table used in the playback apparatus shown in FIG. 1;

FIG. 7 is a table showing an example of a relationship between the content hash table and EVOBUs processed in the playback apparatus shown in FIG. 1;

FIG. 8 is an exemplary diagram showing a data structure of an EVOBU processed in the playback apparatus shown in FIG. 1;

FIG. 9 is an exemplary flowchart of a procedure for a content check process performed by the playback apparatus shown in FIG. 1; and

FIG. 10 is an exemplary block diagram of hardware of the playback shown in FIG. 1.

### DETAILED DESCRIPTION

Various embodiments according to the invention will be described hereinafter with reference to the accompanying drawings. In general, according to one embodiment of the invention, a playback apparatus which plays back a digital content including a plurality of video object units and stored in storage media, includes a pointer check unit which performs a pointer check process to determine whether a value of a pointer included in each of the video object units read out of the storage media is larger than the total number of hash values stored in a content hash table, the content hash table being stored in the storage media and including a plurality of hash entries that store hash values of the video object units, the value of the pointer indicating an hash entry in the content hash table, which stores a hash value of a video object unit corresponding to the pointer, a hash check unit which performs a hash check process to compute a hash value of a video object unit selected at a given probability from among the video object units read out of the storage media and to determine whether the computed hash value coincides with a hash value stored in a hash entry indicated by a pointer included in the selected video object unit, and a playback stop unit which performs a playback stop process to stop playing back the digital content when the pointer check unit determines that the value of the pointer is larger than the total number of hash values stored in the content hash table or when the hash check unit determines that the computed hash value does not coincide with the hash value stored in the hash entry indicated by the pointer included in the selected video object unit.

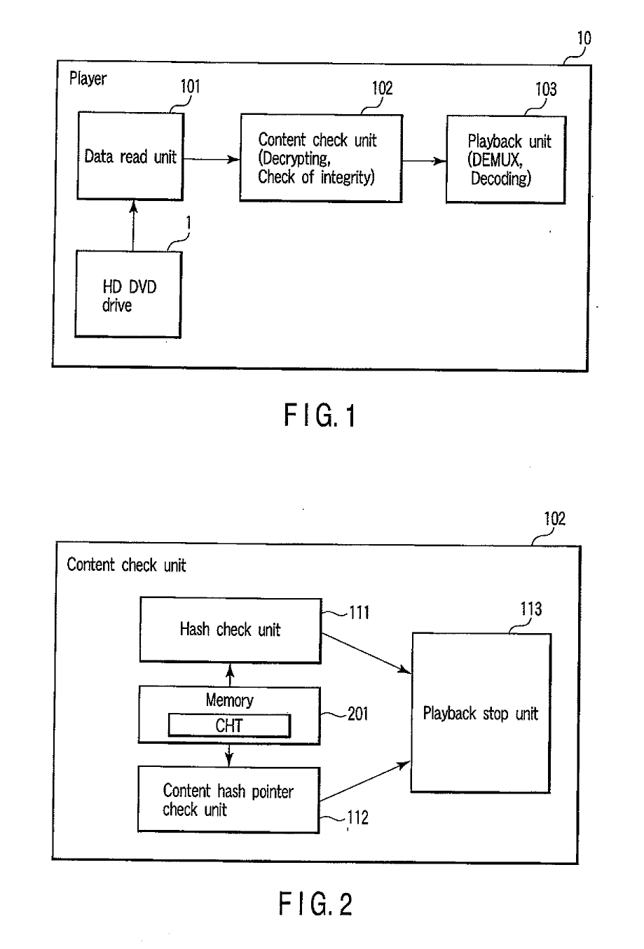

FIG. 1 shows a configuration of a playback apparatus according to an embodiment of the invention. The playback apparatus is a player for playing back a digital content that is composed of data streams such as audiovisual data. In the present embodiment, the player is implemented as a high-definition digital versatile disc (HD DVD) player 10 for playing back a digital content that is recorded in advance on storage media such as an HD DVD.

The HD DVD player 10 includes an HD DVD drive 1, a data read unit 101, a content check unit 102 and a playback unit 103, as shown in FIG. 1.

The digital content stored in optical disk media (HD DVD media) that is driven by the HD DVD drive 1 is an audiovisual content such as a movie and animation. The digital content includes a plurality of video objects VOB such as an enhanced video object EVOB (a primary enhanced video object P-EVOB or a secondary enhanced video object S-EVOB) defined by the HD DVD standard. Each of the video objects VOB includes a plurality of video object units VOBU (a primary enhanced video object unit P-EVOBU, a secondary enhanced video object unit S-EVOBU, etc. defined by the HD DVD standard). Each of the video object units VOBU is data corresponding to a given period of playback time, and includes compression-encoded video data and compression-encoded audio data. The digital content is encrypted for each of the video object units VOBU such as a P-EVOBU and an S-EVOBU.

The data read unit 101 accesses the HD DVD drive 1 and reads the video object units and other different data items from the HD DVD media.

The content check unit 102 is a module for fulfilling the copyright protection function defined by the Advanced Access Content System (AACS). The unit 102 performs a process of decrypting the digital content stored in the HD DVD media and a process of verifying the integrity of the digital content.

The playback unit 103 performs a process of playing back the digital content which has been decrypted by the content check unit 102 and whose integrity has been verified. The unit 103 includes a demultiplexer (DEMUX) for separating each of the video object units VOBU into navigation data, video data and audio data, and a decoder for decoding the navigation data, video data and audio data.

In the HD DVD standard, not only the P-EVOUB and S-EVOUB, but also a video object unit VOBU called a TU, which includes no navigation data, is used. The P-EVOUB, S-EVOUB and TU will be generically called an EVOBU hereinafter.

FIG. 2 shows a configuration of the content check unit 102.

The content check unit 102 includes a hash check unit 111, a content hash pointer check unit 112 and a playback stop unit 113 as function units for verifying the integrity of a digital content.

The hash check unit 111 verifies the integrity of the digital content using a content hash unit CHU.

The content hash unit CHU is an EVOBU that is to perform a hash check process. In the present embodiment, all of the EVOBUs stored in the HD DVD media are each used as the content hash unit CHU. The HD DVD media previously stores a content hash table CHT that stores the hash values of all the EVOBUs. Each of the EVOBUs includes a pointer (content hash pointer CH_PTR) indicating a corresponding one of hash entries in the content hash table CHT. The value of the content hash pointer CH_PTR indicates a entry number of the corresponding hash entry. The value of the content hash pointer CH_PTR is unique to each EVOBU on the HD DVD media. There is a one-to-one correspondence between all the EVOBUs on the HD DVD media and the hash entries in the content hash table CHT. The minimum value of the content hash pointer CH_PTR is one, while the maximum value thereof is equal to the total number of hash entries in the content hash table CHT, or the total number of hash values stored in the content hash table CHT.

Prior to the playback of the digital content, the content hash table CHT is loaded into a memory 201 that is provided in the player 10. The memory 201 is a secure memory that is managed by the content check unit 102.

During the playback of a digital content, the hash check unit 111 performs a hash check process. The hash check process is to compute a hash value of each of the EVOBUs randomly selected with a given probability (e.g., 1%) from among the EVOBUs read out of the HD DVD media and to determine whether the computed hash value coincides with the hash values stored in the corresponding hash entry of the content hash table CHT in the memory 201. The corresponding hash entry is indicated by the values of the content hash pointer CH_PTR included in the selected each EVOBU.

The hash check process is performed only for the EVOBUs randomly selected with a given probability. The integrity of the digital content can thus be verified while reducing the load of the hash check process from the player 10.

If the computed hash value does not coincide with the hash value stored in the corresponding hash entry of the content hash table CHT, the digital content read out of the HD DVD media is an unauthorized content including the falsified EVOBU. In this case, the play stop unit 113 immediately stops the playback of the digital content. Even though a malicious person makes pirated HD DVD media such as a secondary video set whose digital content is partly falsified, the falsified digital content can be prevented from being played back.

If, however, the value of a content hash pointer CH_PTR is altered to an unauthorized value, it is likely that the hash check process cannot be performed correctly. To prevent this, the content check unit 102 has the hash pointer check unit 112.

The content hash pointer check unit 112 performs a pointer check process for each of the EVOBUs read out of the HD DVD media during the playback of a digital content. In this pointer check process, the unit 112 verifies the integrity of the value of the content hash pointer CH_PTR included in each of the EVOBUs read out of the HD DVD media. More specifically, the unit 112 determines whether the value of the content hash pointer CH_PTR is larger than the total number of hash values stored in the content hash table CHT.

As described above, the total number of hash values in the content hash table CHT is equal to the total number of hash entries stored in the content hash table CHT. There is a one-to-one correspondence between all the EVOBUs on the HD DVD media and the hash entries in the content hash table CHT. In the authorized digital content, therefore, the value of the content hash pointer CH_PTR included in every EVOBU must be not larger than the total number of hash values stored in the content hash table CHT.

If the content hash pointer check unit 112 detects an EVOBU whose content hash pointer CH_PTR has a value that is larger than the total number of hash values stored in the content hash table CHT, the EVOBU can be determined as a falsified, unauthorized one.

When the content hash pointer check unit 112 detects the unauthorized EVOBU, the playback stop unit 113 immediately stops the playback of the digital content. The above pointer check process is performed for all of the EVOBUs. Even though a malicious person replaces an EVOBU with an unauthorized EVOBU including a content hash pointer CH_PTR having an invalid value, the falsified digital content can reliably be prevented from being played back.

As described above, in the present embodiment, the hash check process is carried out for the EVOBUs randomly selected with about 1% probability during the playback of a digital content, and the pointer check process is performed for all of the EVOBUs during the playback of a digital content.

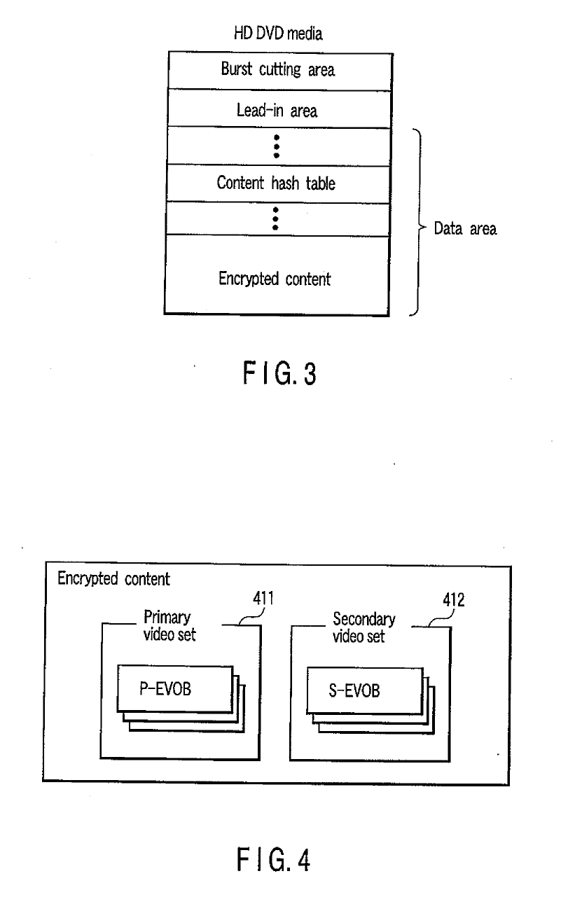

FIG. 3 shows a physical data structure of the HD DVD media.

The HD DVD media has a burst cutting area, a lead-in area and a data area in order from the innermost radius thereof. The data area stores a content hash table, an encrypted digital content, and the like. The content hash table includes hash values corresponding to all of the EVOBUs on the HD DVD media. In other words, the content hash table includes hash entries corresponding to all of the EVOBUs, and each of the hash entries stores a hash value of its corresponding EVOBU. The hash value corresponding to each of the EVOBUs is computed by applying a one-way function to the content of each of the EVOBUs and recorded in the content hash table at the time of manufacture of the HD DVD media.

FIG. 4 shows the structure of a digital content that is encrypted.

The encrypted digital content, which includes a primary video set 411 and a secondary video set 412, can be recorded on the HD DVD media. The primary video set 411 is a title set including compression-encoded main video data and compression-encoded main audio data. It is composed of one or more primary enhanced video objects (P-EVOB). The primary enhanced video objects are main AV data streams.

The secondary video set 412 complements the primary video set 411. The secondary video set 412 is a title set including compression-encoded sub-video data and compression-encoded sub-audio data. It is composed of one or more secondary enhanced video objects (S-EVOB). The secondary enhanced video objects are sub-AV data streams.

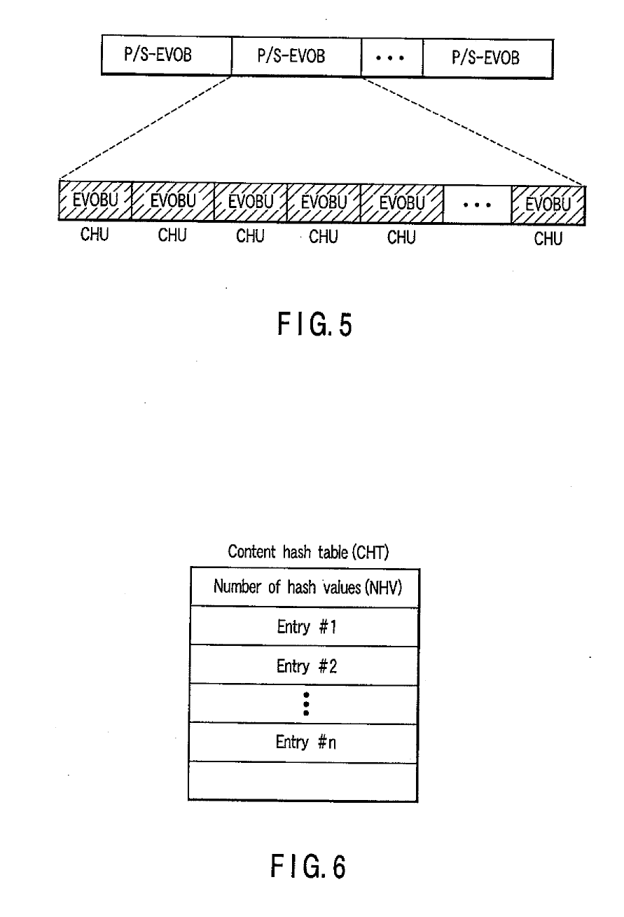

Referring to FIG. 5, each of the EVOBs (P-EVOB, S-EVOB) includes a plurality of EVOBUs. Each of the EVOBUs is used as a content hash unit CHU.

FIG. 6 shows an example of the content hash table CHT.

The content hash table CHT has hash entries the number of which is equal to the number of EVOBUs on the HD DVD media. Each hash entry previously stores a hash value computed from an EVOBU corresponding to the hash entry. The content hash table CHT previously stores the number of hash values (NHV). The NHV is information representing the total number of hash values stored in the content hash table CHT.

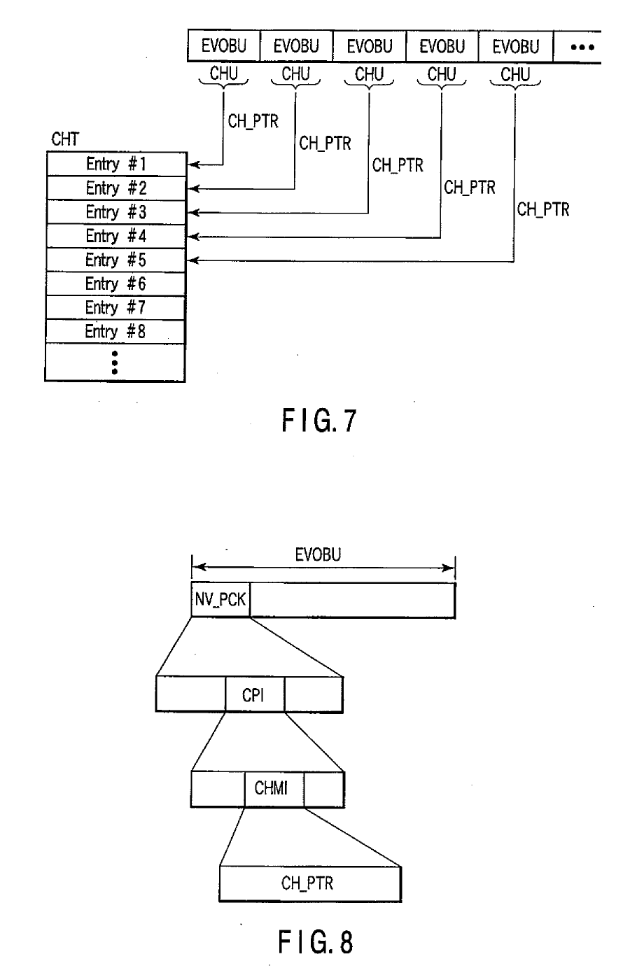

FIG. 7 shows a relationship between the EVOBUs and the content hash table CHT.

As described above, the content hash table CHT stores a hash value corresponding to each of the EVOBUs on the DVD media. The content hash pointer CH_PTR in each EVOBU brings the EVOBU into correspondence with one hash entry in the content hash table CHT.

FIG. 8 shows a data structure of an EVOBU.

The EVOBU has a navigation pack NV_PCK including navigation data at the head thereof. The navigation data is information regarding the attribute of AV data (presentation data) in the EVOBU corresponding to the navigation data and the playback control of the AV data. The navigation pack NV_PCK includes a general control information (GCI) packet GCI_PKT. The GCI packet GCI_PKT has content protection information CPI. The content protection information CPI has content hash management information CHMI.

The content hash management information CHMI is a field including a content hash pointer CH_PTR.

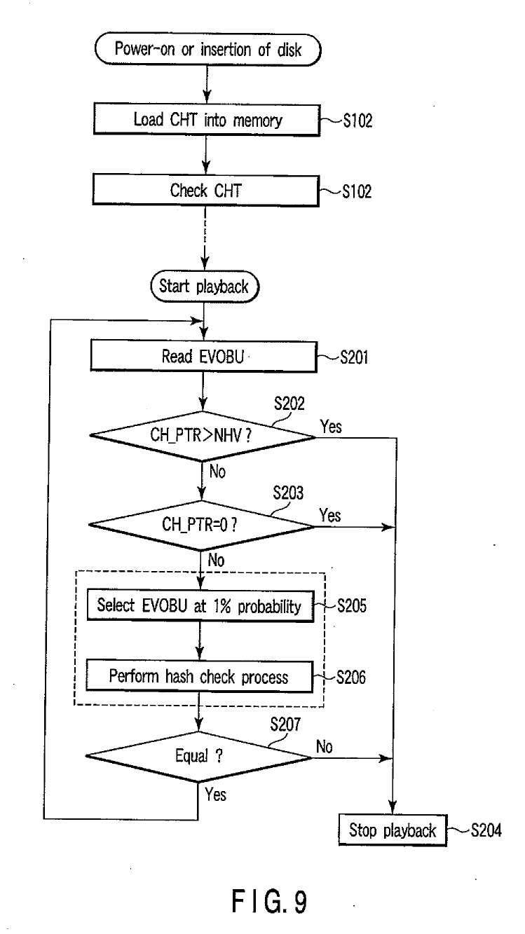

A procedure for the process performed by the content check unit 102 will be described with reference to the flowchart shown in FIG. 9.

Prior to the playback of a digital content, the content check unit 102 loads the content hash table CHT from an HD DVD media (disk) into the memory 201 of the unit 102 using the data read unit 101, upon the power-on of the player 10 or the insertion of the HD DVD media (block S101). When the content hash table CHT is loaded, the unit 102 computes a hash value of the table CHT. When the loading is completed, the unit 102 compares the computed hash value with the hash values assigned in advance to the table CHT to verify the integrity of the table CHT loaded into the memory 201 (block S102). If the verification fails, or if the unit 102 determines that the contents of the table CHT are not correct, it sets the player 10 in its stop state and inhibits the player 10 from playing back the digital content. On the other hand, if the verification succeeds, or if the unit 102 determines that the contents of the table CHT are correct, it allows the player 10 to play back the digital content.

During the playback of the digital content, the content check unit 102 performs the following process.

The content check unit 102 receives an EVOBU from the HD DVD media through the data read unit 101 (block S201). Each time the unit 102 receives an EVOBU, it determines whether the value of the content hash pointer CH_PTR in the received EVOBU is larger than the NHV recorded in the content hash table CHT in the memory 201 (block S202).

If the value of the content hash pointer CH_PTR is larger than the NHV (YES in block S202), the content check unit 102 sets the player 10 in its stop state to stop the playback of the digital content at once (block S204).

If the value of the content hash pointer CH_PTR is not larger than the NHV (NO in block S202), the unit 102 determines whether the value of the content hash pointer CH_PTR is zero (block S203). If the value is zero (YES in block S203), the unit 102 sets the player 10 in its stop state to stop the playback of the digital content at once (block S204).

When the content check unit 102 verifies that the value of the content hash pointer CH_PTR is normal, it performs a hash check process (block S205, block S206). In other words, the hash check process is performed for the EVOBUs in which the values of content hash pointers CH_PTR have been determined to be normal.

In the hash check process, the content check unit 102 randomly selects an EVOBU for the hash check process with 1% ( 1/100) probability. The unit 102 computes the hash value of the selected EVOBU, and compares the computed hash value with the hash value stored in the hash entry of the content hash table CHT in the memory 201. The hash entry is designated by the value of the content hash pointer CH_PTR of the selected EVOBU.

If the above hash values do not coincide with each other (YES in block S207), the content check unit 102 determines that the received EVOBU is a falsified, unauthorized EVOBU, and sets the player 10 in its stop state to stop the playback of the digital content at once (block S204).

As described above, in the present embodiment, even though a malicious person partly falsifies the digital content stored in HD DVD media, the falsified digital content can reliably be prevented from being played back.

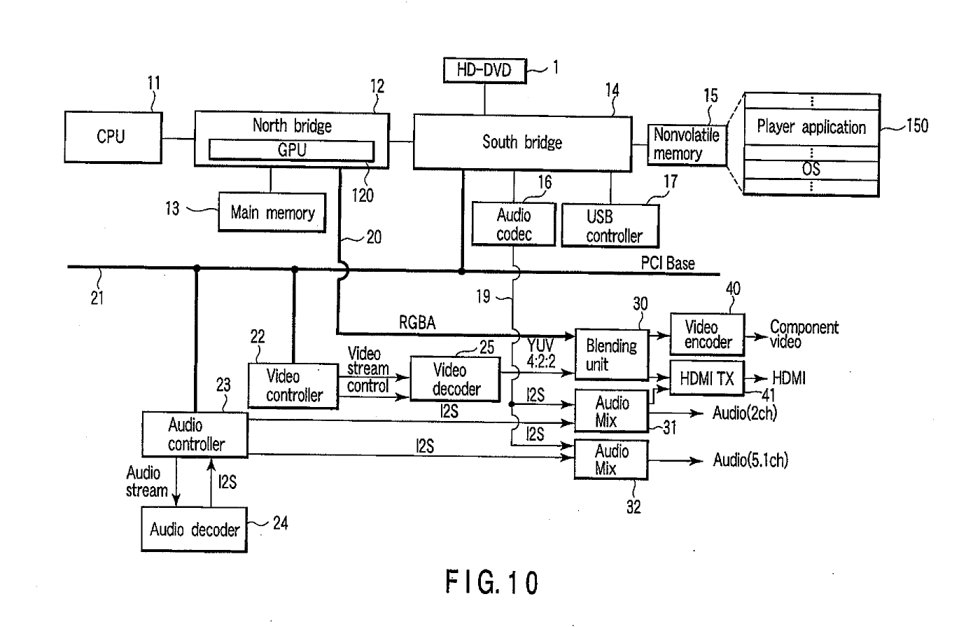

A hardware configuration of the player 10 will be described with reference to FIG. 10.

The player 10 includes a central processing unit (CPU) 11, a north bridge 12, a main memory 13, a south bridge 14, a nonvolatile memory 15, an audio codec 16, a universal serial bus (USB) controller 17, an HD DVD drive 1, an audio bus 19, a graphics bus 20, a peripheral component interconnect (PCI) bus 21, a video controller 22, an audio controller 23, an audio decoder 24, a video decoder 25, a blending unit 30, audio mixers 31 and 32, a video encoder 40, and an AV interface (HDMI-TX) 41 such as a high definition multimedia interface (HDMI).

In the player 10, a player application 150 and an operating system (OS) are installed in advance in the nonvolatile memory 15. The player application 150 is software that runs on the OS to play back an AV content read out of the HD DVD drive 1. The data read unit 101 and content check unit 102, which have been described with reference to FIG. 1, can be implemented by the player application 150. Some functions (DEMUX process, part of the decoding processes) of the playback unit 103, which have been described with reference to FIG. 1, can also be implemented by the player application 150.

The CPU 11 is a processor provided to control the operation of the player 10. The CPU 11 executes the OS and player application 150, which are loaded into the main memory 13 from the nonvolatile memory 15. The north bridge 12 is a bridge device for connecting the local bus of the CPU 11 and the south bridge 14. The north bridge 12 incorporates a memory controller for accessing the main memory 13. The north bridge 12 also incorporates a graphics processing unit (GPU) 120.

The GPU 120 is a graphics controller for generating graphics data (which is also called graphics image data) for forming a graphics screen image, from data that is written by the CPU 11 to a video memory (VRAM). The VRAM is assigned to some storage areas of the main memory 13. The GPU 120 generates graphics data using a graphics operating function such as a bit block transfer. If the CPU 11 writes image data (sub-video, sub-picture, etc.) to three planes on the VRAM, the GPU 120 performs a blending process to combine image data items corresponding to the three planes for each pixel, using a bit block transfer. Graphics data for forming a graphics screen image having the same resolution (e.g., 1920×1080 pixels) as that of the main video can thus be generated.

The GPU 120 supplies the blending unit 30 with graphics data with alpha data (RGBA data) through the graphics bus 20. The graphics data with alpha data is composed of graphics data (digital RGB video signals) and alpha data.

The south bridge 14 controls each of the devices on the PCI bus 21. The south bridge 14 incorporates an integrated drive electronics (IDE) controller for controlling the HD DVD drive 1. Further, the south bridge 14 has a function of accessing the nonvolatile memory 15, USB controller 17 and audio codec 16.

The HD DVD drive 1 is a drive unit for driving storage media such as HD DVD media that stores audio-video (AV) content corresponding to the HD DVD standard.

The audio codec 16 converts the sub-audio data decoded by software into a digital audio signal of an Inter-IC Sound (I2S) format. The audio codec 16 is connected to each of the audio mixers 31 and 32 via the audio bus 19. The audio bus 19 is a transfer path connected between the audio codec 16 and each of the audio mixers 31 and 32. The audio bus 19 allows the digital audio signal generated from the audio codec 16 to be transferred to each of the audio mixers 31 and 32 but not through the PCI bus 21.

The video controller 22 is connected to the PCI bus 21. The video controller 22 is an LSI for interfacing with the video decoder 25. The video stream of the main video data, which is separated from the HD DVD streams by software, is sent to the video decoder 25 via the PCI bus 21 and the video controller 22. The decode control information output from the CPU 11 is also sent to the video decoder 25 via the PCI bus 21 and video controller 22.

The video decoder 25 decodes the main video data to generate a digital YUV video signal for forming a video screen image whose resolution is, for example, 1920×1080 pixels. The digital YUV video signal is supplied to the blending unit 30.

The audio controller 23 is connected to the PCI bus 21. The audio controller 23 is an LSI for interfacing with the audio decoder 24. The audio stream of the main audio data, which is separated from the HD DVD stream by software, is sent to the audio decoder 24 via the PCI bus 21 and the audio controller 23.

The audio decoder 24 decodes the main audio data to generate a digital audio signal of an Inter-IC Sound (I2S) format. The digital audio signal is transmitted to each of the audio mixers 31 and 32 via the audio controller 23.

The blending unit 30 is connected to the CPU 120 and video decoder 25, and performs a blending process to combine the graphics data output from the GPU 120 and the main video data decoded by the video decoder 25 one on another. In this blending process, on the basis of alpha data output from the GPU 120 together with the graphics data (RGB), a digital RGB video signal that forms the graphics data and a digital YUV video signal that forms the main video data are superposed one on another for each pixel (alpha blending process). In the alpha blending process, the main video data is used as a lower-screen image, while the graphics data is used as an upper-screen image that is superposed on the main video data.

The output image data obtained by the blending process is supplied to the video encoder 40 and AV interface (HDMI-TX) 41 as, for example, a digital YUV video signal. The video encoder 40 converts the output image data (digital YUV video signal) obtained by the blending process into a component video signal or an S-video signal, and supplies it to an external display device (monitor) such as a TV receiving set. The AV interface (HDMI-TX) 41 supplies an external HDMI device with digital signals including the digital YUV video signal and digital audio signal.

The audio mixer 31 mixes the sub-audio data decoded by the audio codec 16 and the main audio data decoded by the audio decoder 24 together, and outputs a result of the mixing as a stereo audio signal. The audio mixer 32 mixes the sub-audio data decoded by the audio codec 16 and the main audio data decoded by the audio decoder 24 together, and outputs a result of the mixing as a 5.1-channel audio signal.

All of the functions of the player 10 shown in FIG. 1 can be fulfilled by computer programs. If the computer programs have only to be loaded into a commonly-used computer via a computer-readable storage medium, the computer can be operated as the player 10. In this case, all of the decoding processes can be performed by software, but some or all of them can be done by hardware.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A playback apparatus which plays back a digital content including a plurality of video object units and stored in storage media, comprising:
a pointer check unit which performs a pointer check process to determine whether a value of a pointer included in each of the video object units read out of the storage media is larger than the total number of hash values stored in a content hash table, the content hash table being stored in the storage media and including a plurality of hash entries that store hash values of the video object units, the value of the pointer indicating an hash entry in the content hash table, which stores a hash value of a video object unit corresponding to the pointer;
a hash check unit which performs a hash check process to compute a hash value of a video object unit selected at a given probability from among the video object units read out of the storage media and to determine whether the computed hash value coincides with a hash value stored in a hash entry indicated by a pointer included in the selected video object unit; and
a playback stop unit which performs a playback stop process to stop playing back the digital content when the pointer check unit determines that the value of the pointer is larger than the total number of hash values stored in the content hash table or when the hash check unit determines that the computed hash value does not coincide with the hash value stored in the hash entry indicated by the pointer included in the selected video object unit.

2. The playback apparatus according to claim 1, wherein the content hash table stores information indicating the total number of hash values stored in the content hash table.

3. The playback apparatus according to claim 1, further comprising a loading unit which loads the content hash table into a memory in the playback apparatus,
wherein the hash check process is performed using the content hash table loaded into the memory.

4. The playback apparatus according to claim 3, further comprising a unit which verifies integrity of the content hash table loaded into the memory.

5. The playback apparatus according to claim 1, wherein the pointer check process includes a process to determine whether the value of the pointer is zero, and the playback stop process includes a process to stop playing back the digital content when the value of the pointer is zero.

6. A method of playing back a digital content by a playback apparatus, the digital content including a plurality of video object units and being stored in storage media, the method comprising:
performing a pointer check process to determine whether a value of a pointer included in each of the video object units read out of the storage media is larger than the total number of hash values stored in a content hash table, the content hash table being stored in the storage media and including a plurality of hash entries that store hash values of the video object units, the value of the pointer indicating an hash entry in the content hash table, which stores a hash value of a video object unit corresponding to the pointer;
performing a hash check process to compute a hash value of a video object unit selected at a given probability from among the video object units read out of the storage media and to determine whether the computed hash value coincides with a hash value stored in a hash entry indicated by a pointer included in the selected video object unit; and
performing a playback stop process to stop playing back the digital content when it is determined in the pointer check process that the value of the pointer is larger than the total number of hash values stored in the content hash table or when it is determined in the hash check process that the computed hash value does not coincide with the hash value stored in the hash entry indicated by the pointer included in the selected video object unit.

7. The method according to claim 6, wherein the content hash table stores information indicating the total number of hash values stored in the content hash table.

8. The method according to claim 6, further comprising loading the content hash table into a memory in the playback apparatus,
wherein the hash check process is performed using the content hash table loaded into the memory.

9. The method according to claim 8, further comprising verifying integrity of the content hash table loaded into the memory.

10. The method according to claim 6, wherein the pointer check process includes a process to determine whether the value of the pointer is zero, and the playback stop process includes a process to stop playing back the digital content when the value of the pointer is zero.

11. A program which causes a computer to play back a digital content including a plurality of video object units and stored in storage media, the program comprising:
causing the computer to perform a pointer check process to determine whether a value of a pointer included in each of the video object units read out of the storage media is larger than the total number of hash values stored in a content hash table, the content hash table being stored in the storage media and including a plurality of hash entries that store a hash value of the video object units, the value of the pointer indicating an hash entry in the content hash table, which stores a hash value of a video object unit corresponding to the pointer;
causing the computer to perform a hash check process to compute a hash value of a video object unit selected at a given probability from among the video object units read out of the storage media and to determine whether the computed hash value coincides with a hash value stored in a hash entry indicated by a pointer included in the selected video object unit; and
causing the computer to perform a playback stop process to stop playing back the digital content when the value of the pointer is larger than the total number of hash values stored in the content hash table or when the computed hash value does not coincide with the hash value stored in the hash entry indicated by the pointer included in the selected video object unit.

12. The program according to claim 11, the content hash table stores information indicating the total number of hash values in the content hash table.

13. The program according to claim 11, further comprising causing the computer to load the content hash table into a memory in the playback apparatus,
wherein the hash check process is performed using the content hash table loaded into the memory.

14. The program according to claim 13, further comprising causing the computer to verify integrity of the content hash table loaded into the memory.

15. The program according to claim 11, wherein the pointer check process includes a process to determine whether the value of the pointer is zero, and the playback stop process includes a process to stop playing back the digital content when the value of the pointer is zero.
